(19) United States
(12) Patent Application Publication
(10) Pub. No.: US 2022/0166059 A1
(43) Pub. Date: May 26, 2022

(54) GRAPHITE MATERIAL PARTICLES FOR USE IN LITHIUM-ION SECONDARY BATTERIES, ELECTRODE FOR USE IN LITHIUM-ION SECONDARY BATTERIES, AND METHOD OF PRODUCING GRAPHITE MATERIAL PARTICLES

(71) Applicant: HONDA MOTOR CO., LTD., Tokyo (JP)

(72) Inventor: Kazuki SAIMEN, Saitama (JP)

(21) Appl. No.: 17/455,659

(22) Filed: Nov. 18, 2021

(30) Foreign Application Priority Data
Nov. 20, 2020 (JP) 2020-193111

(51) Int. Cl. H01M 10/0562; H01M 10/0525; H01M 4/133; H01M 4/1393

(52) U.S. Cl. CPC H01M 10/0562; H01M 4/1393; H01M 4/133; H01M 10/0525

(57) ABSTRACT

Provided are graphite material particles that are for use in lithium-ion secondary batteries, make lithium-ion secondary batteries less vulnerable to an increase in internal resistance during charge and discharge cycles, and allow lithium-ion secondary batteries to have high durability to charge and discharge cycles. The graphite material particles for use in a lithium-ion secondary battery each have a structure including: a graphite particle; and a high-dielectric inorganic solid located in and integrated with the graphite particle. The high-dielectric inorganic solid preferably has at least one ion conductivity selected from Li ion conductivity, Na ion conductivity, and Mg ion conductivity, and preferably has an ionic conductivity of 10⁻⁷ S/cm or more and a relative permittivity of 10 or more when in the form of a powder.

This application is based on and claims the benefit of priority from Japanese Patent Application No. 2020-193111, filed on 20 Nov. 2020, the content of which is incorporated herein by reference.

### BACKGROUND OF THE INVENTION

### Field of the Invention

The present invention relates to graphite material particles for use in lithium-ion secondary batteries, to an electrode for use in lithium-ion secondary batteries, and to a method of producing graphite material particles.

### Related Art

The conventional art provides a wide variety of lithium-ion secondary batteries including a lithium ion conducting solid electrolyte. For example, a known lithium-ion secondary battery contains an active material coated with a coating layer including a lithium ion conducting solid electrolyte and a conductive aid, in which the active material is contained in the positive or negative electrode (see, for example, Patent Document 1).

According to Patent Document 1, the coating layer including a lithium ion conducting solid electrolyte and a conductive aid, with which the active material is coated in the positive or negative electrode, can reduce the internal resistance of the lithium-ion secondary battery and protect the active material from deformation during charge and discharge to prevent a decline in charge and discharge cycle characteristics or high-rate discharge characteristics.

Patent Document 1: Japanese Unexamined Patent Application, Publication No. 2003-59492

### SUMMARY OF THE INVENTION

The lithium-ion secondary battery disclosed in Patent Document 1 can produce the above advantageous effects in early charge and discharge cycles, but has the problem of a rapid decline in durability to charge and discharge operations.

The present invention has been made in view of the above, and an object of the present invention is to provide graphite material particles that are for use in lithium-ion secondary batteries, mare lithium-ion secondary batteries less vulnerable to an increase in internal resistance during charge and discharge cycles, and allow lithium-ion secondary batteries to have high durability to charge and discharge cycles.

The present invention has the following aspects.

(1) A graphite material particle for use in a lithium-ion secondary battery, the graphite material particle including a structure including: a graphite particle; and a high-dielectric inorganic solid located in and integrated with the graphite particle.

Aspect (1) of the invention makes it possible to provide graphite material particles that are for use in lithium-ion secondary batteries, make lithium-ion secondary batteries less vulnerable to an increase in internal resistance during charge and discharge cycles, and allow lithium-ion secondary batteries to have high durability to charge and discharge cycles.

(2) The graphite material particle for use in a lithium-ion secondary battery according to aspect (1), in which the high-dielectric inorganic solid has at least one ion conductivity selected from Li ion conductivity, Na ion conductivity, and Mg ion conductivity.

Aspect (2) of the invention makes it possible to trap a free solvent in an electrolytic solution so that quasi-solvation state can be formed to effectively stabilize the solvent and to keep low the amount of decomposition of the electrolytic solution, which can keep the decline in secondary battery capacity at a low level.

(3) The graphite material particle for use in a lithium-ion secondary battery according to aspect (1) or (2), in which the high-dielectric inorganic solid has a relative permittivity of 10 or more when in the form of a powder.

According to aspect (3) of the invention, the high-dielectric inorganic solid can be polarized to trap an acid, which is produced when a fluoro anion or a solvent is decomposed on the graphite particle surface. This can protect a positive electrode active material from corrosion and from charge and discharge-induced cracking or metal elution. This can keep, at a low level, the increase in secondary battery resistance which is associated with charge and discharge cycles.

(4) The graphite material particle for use in a lithium-ion secondary battery according to aspect (2), in which the high-dielectric inorganic solid has an ionic conductivity of 10⁻⁷ S/cm or more.

According to aspect (4) of the invention, a higher solvent-stabilizing effect can be obtained to keep, at a low level, the amount of decomposition of an electrolytic solution and to keep, at a low level, the decline in secondary battery capacity.

(5) The graphite material particle for use in a lithium-ion secondary battery according to aspect (1), having a weight ratio of the high-dielectric inorganic solid to the graphite particle of 0.01% by weight or more and 0.5% by weight or less.

Aspect (5) of the invention makes it possible to provide a lithium-ion secondary battery having high durability to charge and discharge cycles.

(6) An electrode for use in a lithium-ion secondary battery, the electrode including the graphite material particle according to any one of aspects (1) to (5).

Aspect (6) of the invention makes it possible to provide a lithium-ion secondary battery having high durability to charge and discharge cycles.

The present invention also has the following aspect.

(7) A method of producing graphite material particles for use in a lithium-ion secondary battery, the method including: dispersing graphite particles in a solution including an ion-conductive, high-dielectric inorganic solid and a solvent; and removing the solvent.

Aspect (7) of the invention makes it possible to produce graphite material particles that are for use in lithium-ion secondary batteries and each include a structure including a graphite particle and a high-dielectric inorganic solid located in and integrated with the graphite particle.

### BRIEF DESCRIPTION OF THE DRAWINGS

FIG. 1 is a cross-sectional view of a lithium-ion secondary battery according to an embodiment of the present invention;

FIG. 2 is a schematic diagram showing an active material for use in a lithium-ion secondary battery according to an embodiment of the present invention;

FIG. 3 is an electron probe micro analyzer (EPMA) backscattered electron image of graphite material particles according to an example of the present invention; and

FIG. 4 is an EPMA backscattered electron image of graphite material particles produced by a conventional method.

### DETAILED DESCRIPTION OF THE INVENTION

Hereinafter, embodiments of the present invention will be described with reference to the drawings. The embodiments described below are not intended to limit the scope of the present invention.

### Lithium-Ion Secondary Battery

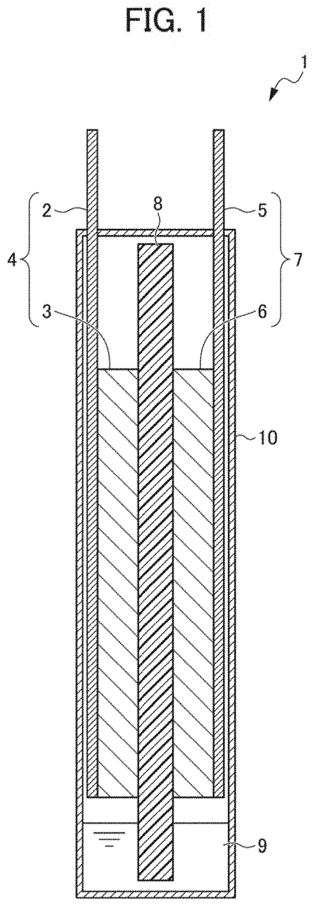

The graphite material particle according to an embodiment of the present invention may be used as, for example, a negative electrode active material for lithium-ion secondary batteries. FIG. 1 shows a lithium-ion secondary battery 1 according to an embodiment of the present invention including a positive electrode 4, a negative electrode 7, a separator 8, an electrolytic solution 9, and a case 10. The positive electrode 4 includes a positive electrode current collector 2 and a positive electrode material mixture layer 3 provided on the positive electrode current collector 2. The negative electrode 7 includes a negative electrode current collector 5 and a negative electrode material mixture layer 6 provided on the negative electrode current collector 5. The separator 8 electrically insulates the positive electrode 4 and the negative electrode 7.

### Current Collector

The positive electrode current collector 2 and the negative electrode current collector 5 may each be made of a foil or sheet of copper, aluminum, nickel, titanium, or stainless steel, a carbon sheet, or a carbon nanotube sheet. The current collector may be made of one of these materials, or if necessary, the current collector may be a metal clad foil made of two or more materials. The thickness of each of the positive electrode current collector 2 and the negative electrode current collector 5 is typically, but not limited to, 5 μm to 100 μm. For structure and performance improvement, the positive electrode current collector 2 and the negative electrode current collector 5 each preferably has a thickness in the range of 7 μm to 20 μm.

### Electrode Material Mixture Layer

The positive electrode material mixture layer 3 includes a positive electrode active material, a conductive aid, and a binding agent (binder). The negative electrode material mixture layer 6 includes a negative electrode active material 11, a conductive aid, and a binding agent (binder).

### Active Material

The positive electrode active material may be, for example, a lithium complex oxide (e.g., LiNiₓCo_{y}Mn_{z}O₂ (x+y+z=1), LiNiₓCo_{y}Al_{z}O₂ (x+y+z=1)) or lithium iron phosphate (LiFePO₄ (LFP)). One of these materials may be used, or two or more of these materials may be used in combination.

Graphite particles are used to form the negative electrode active material 11. The graphite particles may be, for example, particles of graphitizable carbon, hard carbon (non-graphitizable carbon), or graphite. One of these materials may be used, or two or more of these materials may be used in combination. The negative electrode active material 11 will be described in detail later.

### Conductive Aid

Examples of the conductive aid in the positive electrode material mixture layer 3 or the negative electrode material mixture layer 6 include carbon black, such as acetylene black (AB) and Ketjen black (KB), carbon materials, such as graphite powder, and electrically conductive metal powder, such as nickel powder. One of these materials may be used, or two or more of these materials may be used in combination.

### Binder

Examples of the binder used in the positive electrode material mixture layer 3 or the negative electrode material mixture layer 6 include cellulose-based polymers, fluororesin, vinyl acetate copolymers, and rubbers. Specifically, when a solvent-based dispersion medium is used, examples of the binder include polyvinylidene fluoride (PVDF), polyimide (PI), polyvinylidene chloride (PVDC), and polyethylene oxide (PEO), and when a water-based dispersion medium is used, examples of the binder include styrene butadiene rubber (SBR), acrylic acid-modified SBR resin (SBR-based latex), carboxymethyl cellulose (CMC), polyvinyl alcohol (PVA), polytetrafluoroethylene (PTFE), hydroxypropyl methyl cellulose (HPMC), and tetrafluoroethylene-hexafluoropropylene copolymer (FEP). One of these materials may be used, or two or more of these materials may be used in combination.

### Separator

The separator 8 may be, but not limited to, a porous resin sheet (e.g., film, nonwoven fabric) made of a resin, such as polyethylene (PE), polypropylene (PP), polyester, cellulose, or polyamide.

### Electrolytic Solution

The electrolytic solution 9 may include a non-aqueous solvent and an electrolyte. The concentration of the electrolyte is preferably in the range of 0.1 mol/L to 10 mol/L.

### Non-Aqueous Solvent

Examples of the non-aqueous solvent in the electrolytic solution 9 include, but are not limited to, aprotic solvents, such as carbonates, esters, ethers, nitriles, sulfones, and lactones. Specific examples include ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, and γ-butyrolactone.

### Electrolyte

Examples of the electrolyte in the electrolytic solution 9 include LiPF₆, LiBF₄, LiClO₄, LiN(SO₂CF₃), LiN(SO₂C₂F₅)₂, LiCF₃SO₃, LiC₄F₉SO₃, LiC(SO₂CF₃) LiF, LiCl, LiI, Li₂S, Li₃N, Li₃P, Li₁₀GeP₂S₁₂ (LGPS), Li₃PS₄, Li₆PS₅Cl, Li₇P₂S₈I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSi_{y}P_{3-y}O₁₂, Li_{1+x+y}Alₓ(Ti, Ge)₂₋ₓSi_{y}P_{3-y}O₁₂, and Li₄₋₂ₓZnₓGeO₄ (LISICON). Among them, LiPF₆, LiBF₄, or a mixture thereof is preferably used as the electrolyte.

Besides the above, the electrolytic solution 9 may contain an ionic liquid or an ionic liquid and an aliphatic chain-containing polymer, such as polyethylene oxide (PEO) or polyvinylidene fluoride (PVDF) copolymer. The electrolytic solution 9 containing the ionic liquid can flexibly cover the surface of the positive electrode active material and the negative electrode active material, so that preferred contact sites can be formed between the electrolytic solution 9 and the positive and negative electrode active materials.

The electrolytic solution 9 is filled in the space between the positive electrode material mixture layer 3 and the negative electrode material mixture layer 6 and in the pores of the separator 8. The electrolytic solution 9 is also stored at the bottom of the case 10. The mass percentage of the electrolytic solution 9 stored at the bottom of the case 10 may be in the range of 3 to 25% by mass based on the mass of the electrolytic solution 9 filled in the space between the positive electrode material mixture layer 3 and the negative electrode material mixture layer 6 and in the pores of the separator 8. The mass of the electrolytic solution 9 filled in the space between the positive electrode material mixture layer 3 and the negative electrode material mixture layer 6 and in the pores of the separator 8 can be calculated from the specific gravity of the electrolytic solution 9 and the total volume of the space between the positive electrode material mixture layer 3 and the negative electrode material mixture layer 6 and the pores of the separator 8, which can be measured, for example, with a mercury porosimeter. Alternatively, the total volume of the space between the positive electrode material mixture layer 3 and the negative electrode material mixture layer 6 and the pores of the separator 8 may be calculated from the densities of the positive electrode material mixture layer 3 and the negative electrode material mixture layer 6, the densities of the materials of each mixture layer, and the porosity of the separator 8.

The contact between the separator 8 and the electrolytic solution 9 stored in the case 10 allows the positive and negative electrode material mixture layers 3 and 6 to be replenished with the electrolytic solution 9 through the separator 8 upon the consumption of the electrolytic solution 9.

The case 10 accommodates the positive electrode 4, the negative electrode 7, the separator 8, and the electrolytic solution 9. In the case 10, the positive electrode material mixture layer 3 and the negative electrode material mixture layer 6 face each other with the separator 8 in between them, and the electrolytic solution 9 is stored below the positive electrode material mixture layer 3 and the negative electrode material mixture layer 6. An end portion of the separator 8 is immersed in the electrolytic solution 9. The case 10 may have any other configuration and may be any known type used for a secondary battery.

### Negative Electrode Active Material (Graphite Material Particles)

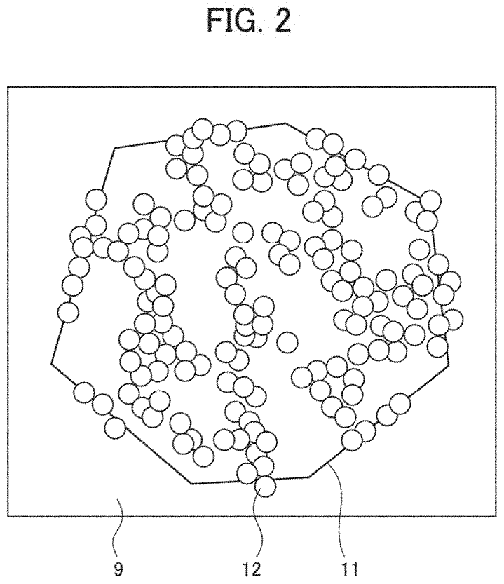

As shown in FIG. 2, graphite material particles as the negative electrode active material 11 each has a structure including a graphite particle and a high-dielectric inorganic solid or solids 12 located in and integrated with the graphite particle. When the negative electrode 7 is filled with a high density of the negative electrode active material 11, the electrolytic solution 9 may poorly penetrate into the negative electrode 7 so that the negative electrode active material 11 may be unevenly impregnated with the electrolytic solution 9. The surface of the negative electrode active material 11, which may be less impregnated with the electrolytic solution 9, may have higher internal resistance when lithium ions are released or injected. In such a state, charge and discharge cycles may cause large variations in potential in the negative electrode active material 11. In such a state, the solvent in the electrolytic solution 9 may undergo decomposition on the surface of the negative electrode active material 11, which may cause depletion of the electrolytic solution 9.

### High-Dielectric Inorganic Solid

The high-dielectric inorganic solid 12 reduces the electrolytic solution 9-induced surface potential of the negative electrode active material 11. This results in a reduction in the lithium-ion interface resistance between the negative electrode active material 11 and the high-dielectric inorganic solid 12 and a reduction in lithium-ion transfer resistance. As a result, an increase in the internal resistance is kept at a low level during charge and discharge cycles of the lithium-ion secondary battery 1, and the solvent in the electrolytic solution 9 is prevented from undergoing decomposition on the surface of the negative electrode active material 11. Moreover, the solvent decomposition-preventing effect of the high-dielectric inorganic solid 12, which results from interaction with the electrolytic solution 9, can inhibit the growth of a solid electrolyte interface (SEI) film on the surface of the negative electrode active material 11, and the electrolytic solution decomposition product-trapping effect of the high-dielectric inorganic solid 12 can prevent acid corrosion of the positive electrode active material. In the conventional art, no high-dielectric inorganic solid is physically incorporated in graphite particles, and no high-dielectric inorganic solid can effectively prevent the decomposition of an electrolytic solution infiltrating into graphite particles. In contrast, according to an embodiment of the present invention, a high-dielectric inorganic solid precursor or a dissolved high-dielectric inorganic solid is allowed to infiltrate into the interior of graphite particles and allowed to be integrated with the graphite particles so that the high-dielectric inorganic solid is deposited in the interior of the graphite particles. Therefore, the electrolytic solution decomposition-preventing effect is also produced in the interior of graphite particles.

A graphite particle for serving as the negative electrode active material 11 has many inner pores with a diameter of less than 100 nm and has a long path through which the high-dielectric inorganic solid 12 is to be deposited in the interior. Moreover, the high-dielectric inorganic solids 12 often have particle sizes of 100 nm or more, which means that it is difficult for a conventional mixing and dispersing method to deposit the high-dielectric inorganic solids 12 in the interior of a graphite particle. In contrast, the graphite material particles according to the embodiment each have a structure including a graphite particle and a high-dielectric inorganic solid or solids 12 located in and integrated with the graphite particle. This structure is effective in preventing the decomposition of the solvent even in the electrolytic solution 9 infiltrating into the graphite particle. As used herein, the expression “located in and integrated with” means a state in which the high-dielectric inorganic solid 12 is physically incorporated in the interior of a graphite particle.

The high-dielectric inorganic solid 12 is highly dielectric. Solid particles obtained by pulverizing a crystalline solid have a permittivity lower than that of the original crystalline solid. Therefore, the high-dielectric inorganic solid according to the embodiment is preferably a product obtained by pulverization with the dielectric property kept as high as possible.

The high-dielectric inorganic solid 12 preferably has a relative permittivity of 10 or more when it is in the form of a powder. In this case, the high-dielectric inorganic solid 12 can be strongly polarized so that it can trap an acid, which is produced through decomposition of the solvent or fluoride anions, such as PF₆⁻, on the graphite particle surface. An acid produced in the lithium-ion secondary battery 1 may corrode the positive electrode active material to cause cracking of the positive electrode active material or metal elution. When the high-dielectric inorganic solid 12 has a relative permittivity of 10 or more in the form of a powder, the positive electrode active material can be prevented from cracking or causing metal elution, so that the increase in the resistance of the lithium-ion secondary battery 1, which is associated with charge and discharge cycles, can be kept at a low level. The high-dielectric inorganic solid 12 more preferably has a relative permittivity of 20 or more when it is in the form of a powder.

The relative permittivity of the high-dielectric inorganic solid 12 in the form of a powder may be determined as shown below. The powder is placed in a 38 mm diameter (R) tablet molding machine for measurement, and compressed to a thickness (d) of 1 to 2 mm using a hydraulic press machine to give a compressed powder. The compressed powder is formed under such conditions as to achieve a powder relative density of 40% or more, which is calculated according to the formula: powder relative density (D_{powder})=(the weight density of the compressed powder/the true specific gravity of the dielectric)×100. The resulting molded product is measured for capacitance (Cₜₒₜₐₗ) at 25° C. and 1 kHz by automatic balancing bridge method using an LCR meter, and the relative permittivity εₜₒₜₐₗ of the compressed powder is calculated from the measurement. The permittivity ε_{powder} of the solid volume part (the relative permittivity ε_{powder} of the powder) may be calculated from the resulting relative permittivity of the compressed powder using Formulas (1) to (3) below, in which is the permittivity of vacuum (=8.854×10⁻¹²) and εₐᵢᵣ is the relative permittivity of air (=1). The contact area A between the compressed powder and the electrode=(R/2)²×Π(1)

Cₜₒₜₐₗ=εₜₒₜₐₗ×ε₀×(A/d) (2)

Eₜₒₜₐₗ=ε_{powder}×D_{powder}+εₐᵢᵣ×(1−D_{powder}) (3)

In order to improve the volume density of the active material filled in the electrode, the high-dielectric inorganic solid 12 preferably has a particle size of ⅕ or less of the particle size of the negative electrode active material 11, and more preferably has a particle size in the range of 0.02 μm to 1 μm. The high-dielectric inorganic solid 12 with a particle size of less than 0.02 μm may fail to maintain high dielectric property and may fail to effectively keep the increase in resistance at a low level.

The high-dielectric inorganic solid 12 preferably has ion conductivity, and more preferably has at least one of Li ion conductivity, Na ion conductivity, and Mg ion conductivity. The high-dielectric inorganic solid 12 with the ion conductivity can trap a free solvent in the electrolytic solution 9 to form a quasi-solvation state. This results in effective stabilization of the solvent in the electrolytic solution 9 and makes the solvent less vulnerable to decomposition. From these points of view, the high-dielectric inorganic solid 12 preferably has an ionic conductivity of 10⁻⁷ S/cm.

As used herein, the term “ionic conductivity” refers to the value determined as shown below.

### Method of Determining Ionic Conductivity

An electrode was formed by Au sputtering on each side of a product obtained by sintering the high-dielectric inorganic solids 12 or on each side of a compressed powder obtained by molding the powder using a tablet molding machine. AC two-terminal method was carried out in which a voltage of 50 mV was applied across the resulting electrodes at a temperature of 25° C. and a frequency of 1 to 10⁶ Hz. The ionic conductivity was calculated from the resulting resistance value through calculating the real number at which the imaginary component of the impedance was zero. The measuring instrument may be, for example, Solartron 1260/1287 (manufactured by Solartron Analytical). The ionic conductivity k is expressed by Formula (4) below, in which A′ is the area of Au, and l is the thickness of the high-dielectric inorganic solid 12.

k=l/(Ri×A′)(S/cm) (4)

The graphite material particle preferably has a weight content of the high-dielectric inorganic solid 12 of 0.01% by weight or more and 0.5% by weight or less, more preferably 0.05% by weight or more and 0.5% by weight or less, based on the weight of the graphite particle.

The high-dielectric inorganic solid 12 preferably includes, for example, Na₃₊ₓ(Sb₁₋ₓ, Snₓ)S₄ (0≤x≤0.1) or Na₃₋ₓSb₁₋ₓWₓS₄ (0≤x≤1). Specifically, the high-dielectric inorganic solid 12 includes Na₃SbS₄, Na₂WS₄, or Na_{2.88}Sb_{0.88}W_{0.12}S₄.

While the lithium-ion secondary battery 1 having the negative electrode material mixture layer 6 containing the high-dielectric inorganic solid 12 as the negative electrode active material 11 has been described, the positive electrode active material in the positive electrode material mixture layer 3 may include the high-dielectric inorganic solid 12.

### Method of Producing Graphite Material Particles

A method of producing graphite material particles for use as the negative electrode active material 11 in the lithium-ion secondary battery 1 according to the embodiment includes dispersing graphite particles in a solution containing a high-dielectric inorganic solid 12 and a solvent; and removing the solvent.

The solvent in which the high-dielectric inorganic solid 12 is to be dissolved may be ion-exchanged water or the like. The step of dispersing graphite particles in a solution containing the high-dielectric inorganic solid 12 dissolved in the solvent may include, but is not limited to, mixing and stirring the solution and the graphite particles using a known mixer or other devices. The stirring may be performed under conditions, for example, at a temperature of 60 to 80° C. for a stirring time of 1 to 10 hours.

The step of removing the solvent may be performed by vaporizing the solvent by at least one of heating and reducing pressure, or may be performed by adding a poor solvent, in which the high-dielectric inorganic solid 12 has low solubility, to precipitate the high-dielectric inorganic solid 12 and then removing the solvent. The poor solvent may be, for example, acetone.

While preferred embodiments of the present invention have been described, the embodiments are not intended to limit the scope of the present invention and may be altered or modified as appropriate.

### EXAMPLES

Hereinafter, the present invention will be described in more detail with reference to examples. It will be understood that the examples are not intended to limit the scope of the present invention.

### Synthesis of High-Dielectric Inorganic Solid

### Synthesis of Na₃SbS₄

Na₃SbS₄ (NSS) was synthesized by the process shown below. In 2,210 mL of ion-exchanged water were dissolved 70.4 g of Na₂S, 75 g of Sb₂S₃, and 21 g of S and stirred at 70° C. for 5 hours. Subsequently, the mixture was cooled to 25° C., from which the undissolved product was removed. Subsequently, 1,400 mL of acetone was added to the product, and the mixture was stirred for 5 hours and then allowed to stand for 12 hours. The product was dried under reduced pressure at 200° C. to give Na₃SbS₄. The resulting sample was subjected to X-ray diffraction (XRD) measurement, which showed that the sample had Na₃SbS₄(H₂O)₉ crystal phase.

### Synthesis of Na₂WS₄

Na₂WS₄ (NWS) was synthesized by the process shown below. In 2,110 mL of ion-exchanged water were dissolved 17.66 g of NaOH and 153.74 g of (NH₄)₂WS₄ and stirred at 70° C. for 5 hours. The mixture was then allowed to stand for 12 hours. Subsequently, the resulting solid was dried under reduced pressure at 150° C. The resulting powder was heated at 275° C. in an Ar atmosphere to give Na₂WS₄.

### Synthesis of Na_{2.88}Sb_{0.88}W_{0.12}S₄

Na_{2.88}Sb_{0.88}W_{0.12}S₄ (NSWS) was synthesized by the process shown below. In ion-exchanged water at 50° C. were dissolved 123.95 g of NSS (shown above) and 18.97 g of NWS (shown above). Water was then removed from the solution at 70° C. Subsequently, the resulting solid was dried under reduced pressure at 150° C. The resulting powder was heated at 275° C. in an Ar atmosphere to give Na_{2.88}Sb_{0.88}W_{0.12}S₄.

### Li₃PO₄

Li₃PO₄ (LPO) with a particle size D50 of 0.8 μm was used.

The ionic conductivity of the NSS, NWS, NSWS, and LPO and the relative permittivity of the NSS, NWS, NSWS, and LPO in the form of a powder were measured. Table 1 shows the results.

TABLE 1

| | | | Relative |
|---|---|---|---|
| | | Ionic | permittivity |
| High-dielectric | | conductivity | in powder |
| inorganic solid | Abbreviation | (S/cm) | form |
| Na₃SbS₄ | NSS | 1.0 × 10⁻³ | 44 |
| Na₂WS₄ | NWS | 1.0 × 10⁻⁷ | 30 |
| Na_{2.88}Sb_{0.88}W_{0.12}S₄ | NSWS | 4.0 × 10⁻³ | 50 |
| Li₃PO₄ | LPO | 1.0 × 10⁻⁷ | 28 |

### Preparation of Graphite Material Particles

### Example 1

In 200 mL of ion-exchanged water were mixed 199.8 g of graphite particles (96.4% by weight in the negative electrode material composition) and 0.2 g of NSS (the high-dielectric inorganic solid obtained as shown above) (0.1% by weight in the negative electrode material composition). The mixture was heated and stirred at 50° C. for 5 hours. The water was then removed from the mixture at 70° C. The product was dried under reduced pressure at 120° C. to give graphite material particles of Example 1.

### Examples 2 to 7 and Comparative Example 1

Graphite material particles of Examples 2 to 7 were prepared as in Example 1 except that the weight contents of the graphite particles and the high-dielectric inorganic solid in the negative electrode material composition and the type of the high-dielectric inorganic solid were changed as shown in Table 2. In Comparative Example 1, no high-dielectric inorganic solid was added. In Comparative Example 2, a negative electrode was prepared as in Example 1 except that LPO insoluble in the solvent was mixed in the ratio shown in Table 2.

### Preparation of Positive Electrode

Acetylene black (AB) as an electron-conductive material, polyvinylidene fluoride (PVDF) as a binder, and N-methyl-2-pyrrolidone (NMP) as a dispersion medium were subjected to premixing and then wet mixing using a planetary centrifugal mixer to give a premix slurry. Subsequently, Li₁Ni_{0.6}Co_{0.2}Mn_{0.2}O₂ (NCM622) as a positive electrode active material was mixed with the resulting premix slurry. The mixture was subjected to a dispersion process using a planetary mixer to give a positive electrode material paste. The positive electrode material paste had a mass composition ratio of NCM622, AB, and PVDF of 94:4.2:1.8. NCM622 had a median diameter of 12 μm. Next, the resulting positive electrode material paste was applied to a positive electrode current collector made of aluminum, then dried, and compressed using a roll press. The product was then dried in vacuo at 120° C. to form a positive electrode plate having a positive electrode material mixture layer. The resulting positive electrode plate was punched into a size of 30 mm×40 mm so that a positive electrode was obtained.

### Preparation of Negative Electrode

An aqueous solution of carboxymethyl cellulose (CMC) as a binder and acetylene black (AB) as an electron-conductive material were premixed using a planetary mixer. Subsequently, the graphite material particles (MGr) according to one of the examples and comparative examples were added as a negative electrode active material to the mixture, and further premixed using a planetary mixer. Subsequently, water as a dispersion medium and styrene butadiene rubber (SBR) as a binder were added to the mixture, which was subjected to a dispersion process using a planetary mixer to give a negative electrode material paste. The negative electrode material paste had a mass composition ratio of MGr, AB, CMC, and SBR of 96.5:0.1:1.0:1.0:1.5. Natural graphite has a median diameter of 12 μm. Next, the resulting negative electrode material paste was applied to a negative electrode current collector made of copper, then dried, and compressed using a roll press. The product was dried in vacuo at 130° C. to give a negative electrode plate having a negative electrode material mixture layer. The resulting negative electrode plate was punched into a size of 34 mm×44 mm so that a negative electrode was obtained.

### Preparation of Lithium-Ion Secondary Battery

An aluminum laminate (manufactured by Dai Nippon Printing Co., Ltd.) for a secondary battery was heat-sealed to form a bag-shaped case. A separator was placed between the positive and negative electrodes, which were prepared as shown above. The resulting laminate was placed in the case. After an electrolytic solution was injected into the interface between the electrodes, the case was sealed at a reduced pressure of 95 kPa so that a lithium-ion secondary battery was obtained. The separator was a polyethylene microporous membrane with its one side coated with alumina particles of about 5 μm. The electrolytic solution was a solution of 1.2 mol/L LiPF₆ as an electrolyte salt in a mixed solvent of ethylene carbonate, ethyl methyl carbonate, and dimethyl carbonate in a volume ratio of 30:30:40.

### Evaluation

The lithium-ion secondary battery produced using the graphite material particles of each of Examples 1 to 7 and Comparative Example 1 was evaluated as shown below.

### Initial Performance (Discharge Capacity)

The resulting lithium-ion secondary battery was allowed to stand at a measurement temperature (25° C.) for 1 hour, then charged at a constant current of 8.4 mA until 4.2 V was reached, subsequently charged at a constant voltage of 4.2 V for 1 hour, then allowed to stand for 30 minutes, and then discharged at a constant current of 8.4 mA until 2.5 V was reached. The process was repeated 5 times, in which the initial discharge capacity (mAh) was defined as the discharge capacity at the fifth discharge. Table 2 shows the results. The current value at which the discharge was completed in 1 hour was normalized to 1 C with respect to the resulting discharge capacity.

### Initial Performance (Initial Cell Resistance)

After the measurement of the initial discharge capacity, the lithium-ion secondary battery was allowed to stand at a measurement temperature (25° C.) for 1 hour and then charged at 0.2 C such that the charge level (state of charge (SOC)) reached 50%, and then allowed to stand for 10 minutes. Subsequently, the lithium-ion secondary battery was pulse-discharged at a C rate of 0.5 C for 10 seconds, during which the voltage was measured. The current value was plotted on the horizontal axis, and the 10 second-discharge voltage for the current at 0.5 C was plotted on the vertical axis. Next, after being allowed to stand for 10 minutes, the lithium-ion secondary battery was supplementarily charged until SOC returned to 50%, and then further allowed to stand for 10 minutes. The operation shown above was performed at each of the C rates 1.0 C, 1.5 C, 2.0 C, 2.5 C, and 3.0 C, and the 10 second-discharge voltage was plotted against the current value at each C rate. The internal resistance (Ω) of the lithium-ion secondary battery obtained in each example was defined as the slope of an approximate straight line obtained from the plots by least squares method. Table 2 shows the results.

### Performance (Discharge Capacity) after Endurance Test

In a thermostatic chamber at 45° C., the lithium-ion secondary battery was subjected to a charge and discharge cycle endurance test including 500 cycles of constant-current charging to 4.2 V at a charge rate of 1 C and then constant-current discharging to 2.5 V at a discharge rate of 2 C. After the completion of the 500 cycles, the lithium-ion secondary battery was allowed to stand for 24 hours in the thermostatic chamber with the temperature changed to 25° C., then charged at a constant current of 0.2 C until 4.2 V was reached, subsequently charged at a constant voltage of 4.2 V for 1 hour, then allowed to stand for 30 minutes, and then discharged at a discharge rate of 0.2 C until 2.5 V was reached. Subsequently, the discharge capacity (mAh) after the endurance test was measured. Table 2 shows the results.

### Cell Resistance after Endurance Test

After the measurement of the discharge capacity after the endurance test, the lithium-ion secondary battery was charged until SOC (state of charge) reached 50% as in the measurement of the initial cell resistance. Subsequently, the cell resistance (Ω) after the endurance test was determined using the same method as for the measurement of the initial cell resistance. Table 2 shows the results.

### Capacity Retention after Endurance Test

The capacity retention (%) was defined as the percentage ratio of the discharge capacity (mAh) after the endurance test to the initial discharge capacity (mAh). Table 2 shows the results.

### Rate of Increase in Resistance after Endurance Test

The rate (%) of increase in cell resistance was defined as the percentage ratio of the cell resistance (Ω) after the endurance test to the initial cell resistance (Ω). Table 2 shows the results.

### EPMA Measurement

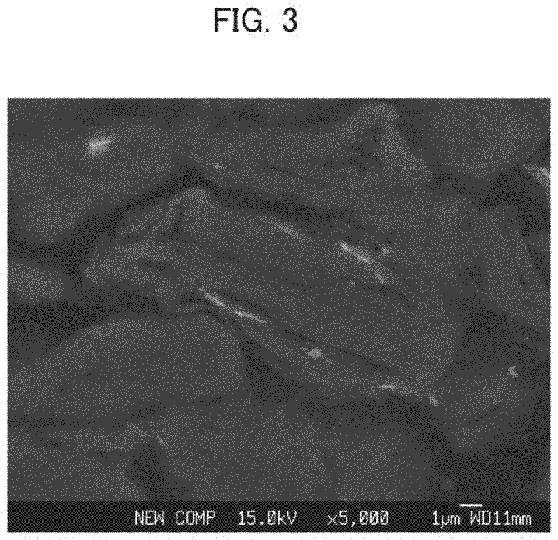

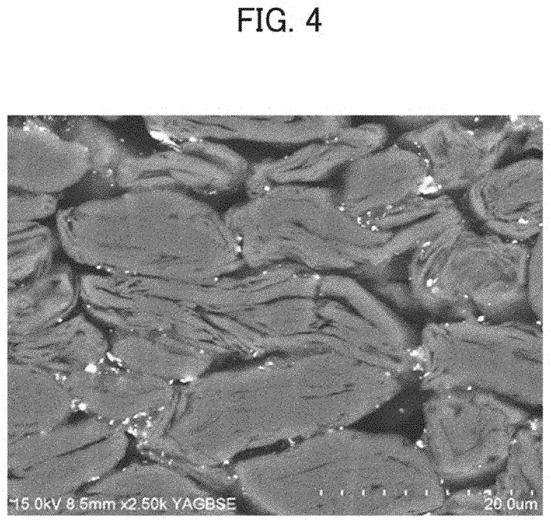

Backscattered electron images of cross-sections of the graphite material particles of Example 5 and Comparative Example 2 were taken using an electron probe micro analyzer (EPMA) (JXA-8500F manufactured by JEOL Ltd.). FIG. 3 shows the EPMA image of the particles of Example 5, and FIG. 4 shows the EPMA image of the particles of Comparative Example 2. In FIGS. 3 and 4, the brightest part indicates the high-dielectric inorganic solid, the gray part indicates the graphite particle, and the darkest part indicates the void. From FIGS. 3 and 4, it has been found that the high-dielectric inorganic solid is located in and integrated with the graphite particle in the graphite material particle of Example 5. On the other hand, it has been found that no high-dielectric inorganic solid is located in the graphite particle in the graphite material particle of Comparative Example 2.

TABLE 2

| | | | | | | | | | Comparative | Comparative |
|---|---|---|---|---|---|---|---|---|---|---|
| | | Example 1 | Example 2 | Exmple 3 | Example 4 | Example 5 | Example 6 | Example 7 | Example 1 | Example 2 |
| High- | Where to add | Negative | Negative | Negative | Negative | Negative | Negative | Negative | — | Negative |
| dielectric | | electrode | electrode | electrode | e1ectrode | electrode | elecrode | electrode | | electrode |
| inorganic | Type (abbreviation) | NSS | NSS | NSS | NSS | NSS | NWS | NSWS | — | LPO |
| solid | | | | | | | | | | |
| Positive | Positive electrode | 94.0 | 94.0 | 94.0 | 94.0 | 94.0 | 94.0 | 94.0 | 94.0 | 94.0 |
| electrode | active material | | | | | | | | | |
| material | Acetylene black | 4.2 | 4.2 | 4.2 | 4.2 | 4.2 | 4.2 | 4.2 | 4.2 | 4.2 |
| composition | PVdF | 1.8 | 1.8 | 1.8 | 1.8 | 1.8 | 1.8 | 1.8 | 1.8 | 1.8 |
| Negative | Graphite particles | 96.49 | 96.45 | 96.4 | 96.2 | 96.0 | 96.4 | 96.4 | 96.5 | 96.0 |
| electrode | High-dielectric | 0.01 | 0.05 | 0.1 | 0.3 | 0.5 | 0.1 | 0.1 | — | 0.5 |
| material | inorganic solid | | | | | | | | | |
| composition | Acetyline black | 1.0 | 1.0 | 1.0 | 1.0 | 1.0 | 1.0 | 1.0 | 1.0 | 1.0 |
| (wt %) | CMC | 1.0 | 1.0 | 1.0 | 1.0 | 1.0 | 1.0 | 1.0 | 1.0 | 1.0 |
| | SBR | 1.5 | 1.5 | 1.5 | 1.5 | 1.5 | 1.5 | 1.5 | 1.5 | 1.5 |
| Initial | Discharge capacity | 42.5 | 42.5 | 42.7 | 43.0 | 43.2 | 42.7 | 42.6 | 42.5 | 41.5 |
| performance | (mAh) | | | | | | | | | |
| | Initial cell resistance | 924.7 | 961.3 | 1007.1 | 1052.8 | 1144.4 | 1007.1 | 1007.1 | 915.1 | 1004.0 |
| | (Ω) | | | | | | | | | |
| Performance | Discharge capacity | 37.7 | 38.5 | 39.8 | 40.5 | 40.8 | 39.1 | 40.0 | 37.4 | 36.0 |
| after | (mAh) | | | | | | | | | |
| endurance | Cell resistance after | 1354.7 | 1331.5 | 1294.2 | 1310.9 | 1413.4 | 1358.2 | 1220.9 | 1359.6 | 1420.0 |
| test | endurance test (Ω) | | | | | | | | | |

| | | | | | | | | | |
|---|---|---|---|---|---|---|---|---|---|
| Capacity retention after endurance | 88.6 | 90.6 | 93.1 | 94.1 | 94.4 | 91.5 | 93.8 | 88.1 | 86.7 |
| test (%) | | | | | | | | | |
| Rate of increase in resistance after | 147 | 139 | 129 | 125 | 124 | 135 | 121 | 149 | 141 |
| endurance test (%) | | | | | | | | | |

The results in Table 2 indicate that the lithium-ion secondary battery of each of the examples has a capacity retention higher than that of the lithium-ion secondary battery of the comparative example after the endurance test and shows a rate of increase in resistance lower than that shown by the lithium-ion secondary battery of the comparative example after the endurance test. Therefore, it has been demonstrated that the lithium-ion secondary battery of each of the examples has high durability to charge and discharge cycles.

### EXPLANATION OF REFERENCE NUMERALS

1: Lithium-ion secondary battery

11: Negative electrode active material (graphite material particle)

12: High-dielectric inorganic solid

What is claimed is:

1. A graphite material particle for use in a lithium-ion secondary battery, the graphite material particle comprising a structure comprising: a graphite particle; and a high-dielectric inorganic solid located in and integrated with the graphite particle.

2. The graphite material particle for use in a lithium-ion secondary battery according to claim 1, wherein the high-dielectric inorganic solid has at least one ion conductivity selected from Li ion conductivity, Na ion conductivity, and Mg ion conductivity.

3. The graphite material particle for use in a lithium-ion secondary battery according to claim 1, wherein the high-dielectric inorganic solid has a relative permittivity of 10 or more when in a powder form.

4. The graphite material particle for use in a lithium-ion secondary battery according to claim 2, wherein the high-dielectric inorganic solid has an ionic conductivity of 10⁻⁷ S/cm or more.

5. The graphite material particle for use in a lithium-ion secondary battery according to claim 1, having a weight ratio of the high-dielectric inorganic solid to the graphite particle of 0.01% by weight or more and 0.5% by weight or less.

6. An electrode for use in a lithium-ion secondary battery, the electrode comprising the graphite material particle according to claim 1.

7. An electrode for use in a lithium-ion secondary battery, the electrode comprising the graphite material particle according to claim 2.

8. An electrode for use in a lithium-ion secondary battery, the electrode comprising the graphite material particle according to claim 3.

9. An electrode for use in a lithium-ion secondary battery, the electrode comprising the graphite material particle according to claim 4.

10. An electrode for use In a lithium-ion secondary battery, the electrode comprising the graphite material particle according to claim 5.

11. A method of producing graphite material particles for use in a lithium-ion secondary battery, the method comprising: dispersing graphite particles in a solution comprising an ion-conductive, high-dielectric inorganic solid and a solvent; and removing the solvent.
